(19) United States
(12) Patent Application Publication
(10) Pub. No.: US 2025/0269704 A1
(43) Pub. Date: Aug. 28, 2025

(54) VEHICLE UPPER STRUCTURE

(71) Applicant: TOYOTA JIDOSHA KABUSHIKI KAISHA, Aichi-ken (JP)

(72) Inventors: Kouichirou UENO, Nagoya-shi (JP); Motoya SAKABE, Nissin-shi (JP)

(21) Appl. No.: 19/059,263

(22) Filed: Feb. 21, 2025

(30) Foreign Application Priority Data
Feb. 26, 2024 (JP) 2024-026927

(51) Int. Cl. B60J 5/10

(52) U.S. Cl. CPC B60J 5/107

(57) ABSTRACT

The vehicle upper structure has a hatchback door and a rail garnish covering the roof side rail. The rail garnish is provided along the roof side rail and includes a base whose rear end extends to near the front end of the hatchback door (upper end) in the closed state, and a wall portion that extends downward from the rear end of the base. The upper end of the rear side surface of the wall portion is sloped backward.

### CROSS REFERENCE TO RELATED APPLICATION

This application claims priority to Japanese Patent Application No. 2024-026927 filed on Feb. 26, 2024, which is incorporated herein by reference in its entirety including the specification, claims, drawings, and abstract.

### TECHNICAL FIELD

The present disclosure relates to improvements to vehicle upper structure.

### BACKGROUND

Conventionally, vehicles are equipped with rail garnishes covering roof side rails (e.g., Patent Document 1). Roof side rails are frame members that connect the upper ends of the front pillar, center pillar, and rear pillar and extend in the front-rear direction of the vehicle. The rail garnish is primarily a decorative component.

### CITATION LIST

PATENT LITERATURE 1: JP2019-026239A

FIG. 2 is a side view of a vehicle with a hatchback door 10, which is a flip-up type door at the rear of the vehicle, and a rail garnish 14 covering the roof side rail 12. FIG. 3 is an enlarged cross-sectional view of part A of FIG. 2 and a cross-sectional view of a conventional vehicle upper structure 20. In the drawings to which this specification refers, “FR” represents forward in the front-back direction of the vehicle, and the opposite direction of “FR” represents backward in the front-back direction of the vehicle. In this specification, forward in the vehicle front-back direction is simply described as forward, and backward in the vehicle front-back direction is simply described as backward. UP″ represents vertical upward, and the opposite direction of ‘UP’ represents vertical downward. In this specification, when a position is described as above a certain location, it means not only vertically upward from that location, but also diagonally upward from that location. When the term “below a certain position” is used herein, it means not only vertically downward from the said position but also diagonally downward from the said position.

The rail garnish 14 that the conventional vehicle upper structure 20 has is described as rail garnish 14a. The rail garnish 14a is formed of steel plate. Referring to FIG. 3, the rail garnish 14a is provided along the roof side rail 12 and comprises a base 22 extending in the front-rear direction of the vehicle and a wall portion 24 extending downwardly from the rear end 22a of the base 22. In particular, the wall portion 24 of the rail garnish 14a extends straight and almost vertically downward from the rear end 22a of the base 22.

The rear end 22a of the base 22 extends to the vicinity of the front end 10a of the hatchback door 10 in the closed state. The sign 10b shown in FIG. 3 is the upper end of the hatchback door 10 in the closed state. As shown by the solid line in FIG. 3, in the closed state, the upper end 10b extends in the front-rear direction of the vehicle (in an abbreviated horizontal direction). The front end 10a of the hatchback door 10 is the front end of the upper end 10b.

The hatchback door 10 opens and closes by rotating around a rotation axis parallel to the vehicle width direction. When the hatchback door 10 opens from the closed state, the upper end 10b rotates so that the front end 10a moves downward, as indicated by the arrow AR in FIG. 3. In FIG. 3, the rotation of the upper end 10b is shown as a dashed line.

When the rotation axis of the hatchback door 10 is lower than the upper end 10b of the hatchback door 10 in the closed state (not to mention that the rotation axis is behind the front end 10a of the hatchback door 10), as the hatchback door 10 (upper end 10b) rotates from the closed state to the open state, the front end 10a moves forward. Here, since the rotating upper end 10b must not contact the wall portion 24 of the rail garnish 14a, the wall portion 24 is provided in front of the most front position Pf in the movement path of the front end 10a as the hatchback door 10 opens and closes (that is, the rotation of the upper end 10b).

Thus, in the past, the wall portion 24 was provided almost vertically in front of the most front position Pf. The front end 10a of the hatchback door 10 in the closed state may be located rearward of the most front position Pf. In such a case, the gap G1 between the rail garnish 14a (rear end 22a of the base 22) and the closed hatchback door 10 (front end 10a of the upper end 10b) is inevitably larger than the gap between the wall portion 24 and the most front position Pf. In other words, the problem arose that the sight gap G1 became larger.

The purpose of the vehicle upper structure disclosed herein is to reduce the sight gap between the rail garnish and the hatchback door.

### SUMMARY

A vehicle upper structure disclosed in the present specification comprising:
a hatchback door; and
a rail garnish covering a roof side rail, wherein
the rail garnish includes:
a base provided along the roof side rail, and having a rear end which extends to a region proximate a front end of the hatchback door in a closed state; and
a wall extending downward from a rear end of the base, and
an upper end portion of a rear side surface of the wall is inclined forward in a front-rear direction of the vehicle toward a lower side.

A lower end portion of the rear side surface of the wall may be inclined rearward in the front-rear direction of the vehicle toward a lower side.

A position of the lower end portion of the rear side surface of the wall in the front-rear direction of the vehicle may be at the same position as a position of the upper end portion of the rear side surface of the wall in the front-rear direction of the vehicle, or is at a rear side in the front-rear direction of the vehicle than the position of the upper end portion of the rear side surface of the wall in the front-rear direction of the vehicle.

The rear side surface of the wall may be curved along a trajectory of movement of the front end of the hatchback door due to opening or closing of the hatchback door.

The rail garnish may be made of a resin.

The vehicle upper structure disclosed herein allows for a smaller sight gap between) the rail garnish and the hatchback door.

### BRIEF DESCRIPTION OF DRAWINGS

Embodiment of the present disclosure will be described based on the following figures, wherein:

FIG. 1 is cross-sectional view of the vehicle upper structure.

FIG. 2 is side view of a vehicle with a hatchback door and rail garnish.

FIG. 3 is cross-sectional view of a conventional vehicle upper structure.

### EMBODIMENTS

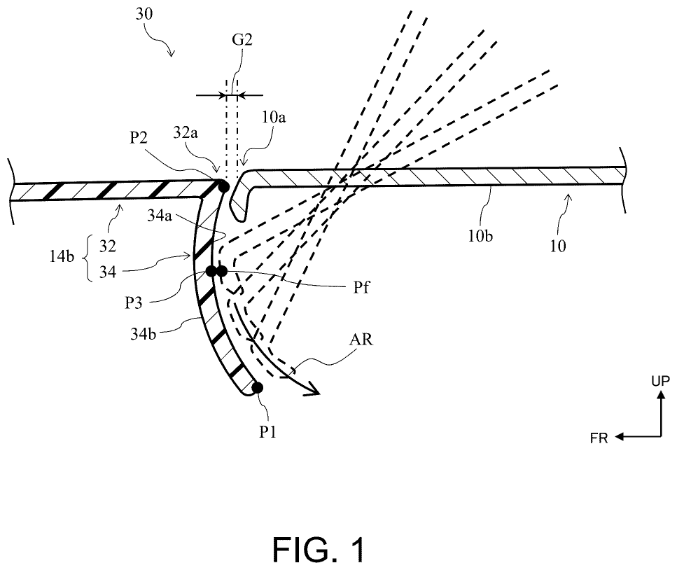

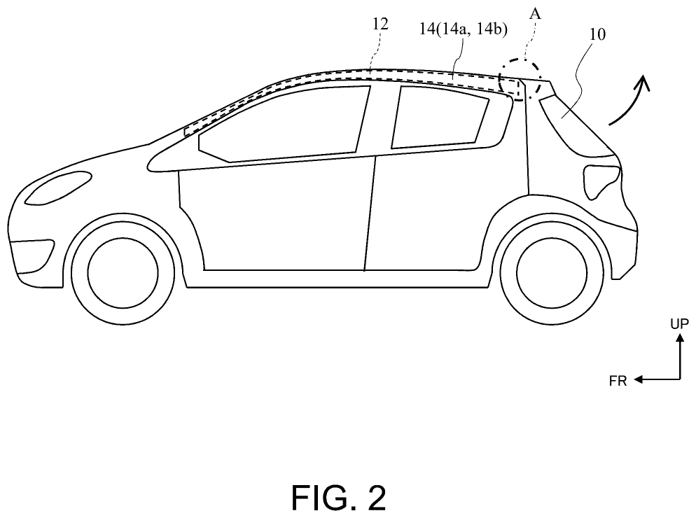

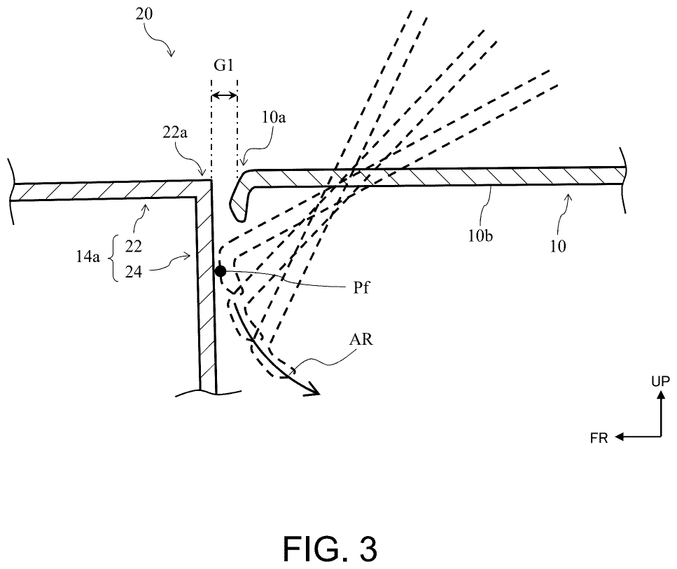

FIG. 1 is a cross-sectional view of the 30 vehicle upper structure. FIG. 1 is an enlarged cross-sectional view of part A of FIG. 2, as well as FIG. 3. However, the shape of the rail garnish 14 differs from each other between the vehicle upper structure 30 of this embodiment and the conventional vehicle upper structure 20. The rail garnish 14 of the vehicle upper structure 30 of this embodiment is described as rail garnish 14b.

The vehicle upper structure 30 has a hatchback door 10 and a rail garnish 14b covering the roof side rail 12. The structure of the hatchback door 10 and its movement when opening and closing in the vehicle upper structure 30 are the same as those of the conventional vehicle upper structure 20, so the same symbols as in FIG. 3 are used and their description is omitted.

The rail garnish 14b is made of resin, unlike the conventional rail garnish 14a. The rail garnish 14b comprises a base 32 provided along the roof side rail 12 and a wall portion 34 extending downward from the rear end 32a of the base 32. The base 32, like the base 22 of the conventional rail garnish 14a, extends in the front-rear direction of the vehicle and its rear end 32a extends to the vicinity of the front end 10a of the hatchback door 10 (upper end 10b) in the closed state.

In the rail garnish 14b, the upper end of the rear side surface 34a of the wall portion 34 is sloped downward and forward. In other words, the upper end of the rear side surface 34a is a rearward and downward facing slope. In this embodiment, like the rear side surface 34a, the upper end of the front side surface 34b of the wall portion 34 also slopes forward. In other words, in this embodiment, the upper end of the wall portion 34 is warped downward and forward. However, it is sufficient that at least the upper end of the rear side surface 34a slopes forward, and the upper end of the front side surface 34b need not necessarily slope forward. For example, the front side surface 34b may be a plane parallel to the vertical direction.

The lower end of the rear side surface 34a may be sloped backward toward the bottom. In other words, the lower end of the rear side surface 34a is a slope facing backward and upward. In this embodiment, like the rear side surface 34a, the lower end of the front side surface 34b also slopes backward. In other words, in this embodiment, the lower end of the wall portion 34 is warped backward toward the bottom. However, it is sufficient that at least the lower end of the rear side surface 34a slopes backward, and the lower end of the front side surface 34b need not necessarily slope backward. For example, as described above, the front side surface 34b may be a plane parallel to the vertical direction.

The position P1 of the lower end of the rear side surface 34a in the longitudinal direction of the vehicle may be the same position P2 of the upper end of the rear side surface 34a in the longitudinal direction of the vehicle. Alternatively, as shown in FIG. 1, the position P1 of the lower end of the rear side surface 34a in the vehicle longitudinal direction may be rearward of the position P2 of the upper end of the rear side surface 34a in the vehicle longitudinal direction.

In this embodiment, the rear side surface 34a is curved along the movement path (see arrow AR in FIG. 1) of the front end 10a of the hatchback door 10 (upper end 10b) as the hatchback door 10 is opened and closed. In other words, the rear side surface 34a has a circular arc shape in the side view. In other words, as the rear side surface 34a moves downward from the upper end of the rear side surface 34a (position P2), the position of the rear side surface 34a gradually moves forward in the front-back direction of the vehicle. Then, position P3, which is opposite to (at the same height as) the most front position Pf in the movement trajectory of the front end 10a, becomes the most front position in the rear side surface 34a. Position P3 is the same position as the position of the rear side of the wall portion 24 in the front-back direction of the vehicle in the conventional vehicle upper structure 20 (see FIG. 3). Furthermore, as one moves downward from position P3, the position of the rear side surface 34a in the front-back direction of the vehicle gradually moves backward to the lower end (P1).

The shape of the rear side surface 34a of the vehicle upper structure 30 of this embodiment, in particular, the wall portion 34 of the rail garnish 14b, is as described above. In this embodiment of the vehicle upper structure 30, the upper end of the rear side surface 34a of the wall portion 34 is sloped downward and forward, so that, at least compared to the vehicle upper structure 20 as shown in FIG. 3 (in which the wall portion 24 (rear side) extends straight and almost vertically downward), the rail garnish 14 G2 between the rail garnish 14b and the hatchback door 10 in the closed state can be reduced. Specifically, the clearance gap G2 of the vehicle upper structure 30 is smaller than the difference between position P3 and position P2 in the front-rear direction of the vehicle and the clearance gap G1 of the vehicle upper structure 20.

The lower end of the rear side surface 34a of the wall portion 34 is sloped downward and backward, so that even when the hatchback door 10 is opened (in other words, when the front end 10a of the hatchback door 10 is moved backward), the clearance gap between the rail garnish 14b and the hatchback door 10 The gap between the rail garnish 14b and the hatchback door 10 can be reduced. In addition, the position P1 of the lower edge of the rear side surface 34a in the longitudinal direction of the vehicle is the same as or further rearward than the position P2 of the upper edge of the rear side surface 34a, so that even when the hatchback door 10 is opened wider so that the front end 10a of the hatchback door 10 is the same as or further rearward than when the door is closed The gap between the rail garnish 14b and the hatchback door 10 can be reduced.

In addition, as in the present embodiment, the rear side surface 34a is curved along the path of movement of the front end 10a as the hatchback door 10 opens and closes, so that the clearance between the rail garnish 14b and the hatchback door 10 can be kept small and constant regardless of how the hatchback door 10 opens. The curved track of the hatchback door 10 allows the gap between the rail garnish 14b and the hatchback door 10 to be kept small and constant regardless of how the hatchback door 10 opens.

Furthermore, the fact that the rail garnish 14b is made of resin makes its molding easier than when the rail garnish 14b is at least made of steel plate. Therefore, by having the rail garnish 14b made of resin, the shape of the wall portion 34 (especially the rear side surface 34a) can be easily molded as described above.

Although the embodiments of the vehicle upper structure of the present disclosure have been described above, the vehicle upper structure of the present disclosure is not limited to the above embodiments, and various modifications are possible without departing from the intent thereof.

### REFERENCE SIGNS LIST

10 hatchback door, 10a front end, 10b upper end, 12 roof side rail, 14, 14a, 14b rail garnish, 20,30 vehicle upper structure, 22,32 base, 22a,32a, rear end, 24,34, wall portion, 34a, rear side surface, 34b, front side surface.

1. A vehicle upper structure comprising:
a hatchback door; and
a rail garnish covering a roof side rail, wherein
the rail garnish includes:
a base provided along the roof side rail, and having a rear end which extends to a region proximate a front end of the hatchback door in a closed state; and
a wall extending downward from a rear end of the base, and
an upper end portion of a rear side surface of the wall is inclined forward in a front-rear direction of the vehicle toward a lower side.

2. The vehicle upper structure according to claim 1, wherein
a lower end portion of the rear side surface of the wall is inclined rearward in the front-rear direction of the vehicle toward a lower side.

3. The vehicle upper structure according to claim 2, wherein
a position of the lower end portion of the rear side surface of the wall in the front-rear direction of the vehicle is at the same position as a position of the upper end portion of the rear side surface of the wall in the front-rear direction of the vehicle, or is at a rear side in the front-rear direction of the vehicle than the position of the upper end portion of the rear side surface of the wall in the front-rear direction of the vehicle.

4. The vehicle upper structure according to claim 2, wherein
the rear side surface of the wall is curved along a trajectory of movement of the front end of the hatchback door due to opening or closing of the hatchback door.

5. The vehicle upper structure according to claim 1, wherein
the rail garnish is made of a resin.
